(19) United States
(12) Patent Application Publication
(10) Pub. No.: US 2026/0252185 A1
(43) Pub. Date: Aug. 27, 2026

(54) DIAL CONTROL METHOD AND ELECTRONIC DEVICE

(71) Applicant: ASUSTEK COMPUTER INC., TAIPEI (TW)

(72) Inventor: Po-Sheng CHENG, TAIPEI (TW)

(21) Appl. No.: 19/444,611

(22) Filed: Jan. 9, 2026

(30) Foreign Application Priority Data
Feb. 21, 2025 (CN) 114106581

(51) Int. Cl. G06F 3/0362; G06F 3/0354; G06F 3/04847; G06F 3/0487

(52) U.S. Cl. CPC G06F 3/0362; G06F 3/04847; G06F 3/0487; G06F 3/03547

(57) ABSTRACT

A dial control method applied to an electronic device is provided. The electronic device includes a display and a dial. The display is adapted to display a window of an application program and a user interface corresponding to the dial. The dial reports a rotation count per unit time. The dial control method includes the following steps: obtaining a first level value, and determining an acceleration factor based on the first level value; obtaining a previous rotation count and a current rotation count in sequence by the dial, and calculating a difference value between the previous rotation count and the current rotation count; generating a current acceleration value based on a previous acceleration value, the difference value, and the acceleration factor; generating a change value based on the current acceleration value; and controlling the application program according to the change value. An electronic device implementing the method is also provided.

### CROSS-REFERENCE TO RELATED APPLICATION

This application claims the priority benefit of Taiwan application serial No. 114106581, filed on Feb. 21, 2025. The entirety of the above-mentioned patent application is hereby incorporated by reference herein and made a part of the specification.

### BACKGROUND OF THE INVENTION

### Field of the Invention

The invention relates to a control method and, more particularly, to a dial control method applied to an electronic device.

### Description of the Related Art

With advancements of technology, users have higher and higher requirements for the human-machine interface of electronic products. Compared to button switches, dials provide users with more operating ways. Users input control signals by rotating the dial.

To meet the requirement of quick adjustment, a single adjustment spacing is increased when the value adjustment range is large. However, it is difficult to adjust precisely in areas with the large adjustment range. When the value is adjusted in a single adjustment, it is easy to have a sudden change in value during an operation of the dial.

### BRIEF SUMMARY OF THE INVENTION

A dial control method applied to an electronic device is provided. The electronic device includes a display and a dial, and the display is adapted to display a window of an application program and a user interface corresponding to the dial. The dial reports a rotation count per unit time. The dial control method includes the following steps: obtaining a first level value, and determining an acceleration factor based on the first level value; obtaining a previous rotation count and a current rotation count in sequence by the dial, and calculating a difference value between the previous rotation count and the current rotation count; generating a current acceleration value based on a previous acceleration value, the difference value, and the acceleration factor; generating a change value based on the current acceleration value; and controlling an application program according to the change value.

An electronic device is provided. The electronic device includes a dial, reporting a rotation count per unit time; a display, adapted to display a window of an application program and a user interface corresponding to the dial; a setting unit, adapted to obtain a first level value and determine an acceleration factor based on the first level value; a control unit, electrically connected to the dial, the control unit is configured to obtain a previous rotation count and a current rotation count in sequence by the dial, and calculate a difference value between the previous rotation count and the current rotation count; a calculation unit, electrically connected to the control unit and the setting unit, the calculation unit is configured to generate a current acceleration value based on a previous acceleration value, the difference value, and the acceleration factor, and generate a change value based on the current acceleration value; and a processing unit, electrically connected to the calculation unit and configured to control the application program according to the change value.

In the dial control method of the embodiments, the acceleration factor is set, the difference value between the previous rotation count and the current rotation count in sequence is obtained by the dial. The calculate current acceleration value is calculated based on the different value, the acceleration factor, and the previous acceleration value. Consequently, the output change value is adjusted flexibly by changing the rotation speed or the rotation magnitude of the dial. As a result, a sudden change in value is avoided effectively.

### BRIEF DESCRIPTION OF THE DRAWINGS

FIG. 1 is a block diagram of an electronic device in accordance with one embodiment;

FIG. 2 is a three-dimensional diagram of the electronic device in accordance with one embodiment;

FIGS. 3A and 3B show a dial in accordance with two embodiments of the invention;

FIGS. 4A and 4B show an interface shown by a display in accordance with one embodiment;

FIG. 5 is a flowchart of a dial control method in accordance with a first embodiment;

FIG. 6 is a flowchart of the dial control method in accordance with a second embodiment;

FIG. 7 is a flowchart of the dial control method in accordance with a third embodiment; and

FIG. 8 is a flowchart of the dial control method in accordance with a fourth embodiment.

### DETAILED DESCRIPTION OF THE EMBODIMENTS

The embodiments of the invention are disclosed in detail accompanying following figures. Advantages and features of the application are clearer according to following descriptions and claims. The drawings are shown in a simplified form and imprecise proportions to conveniently and clearly assist to explain purposes of the embodiments.

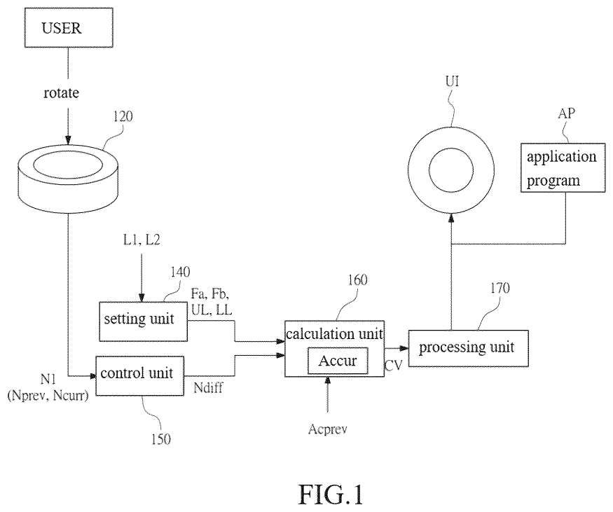

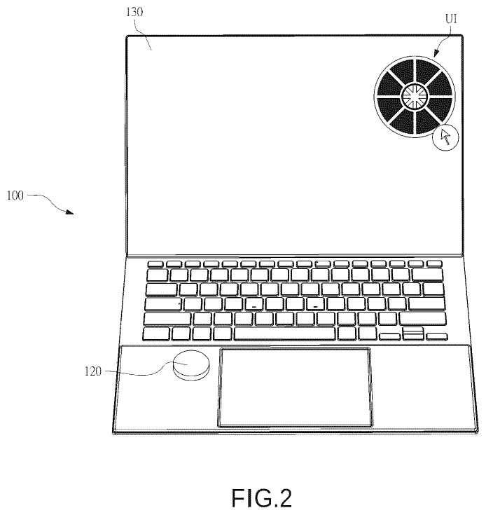

FIG. 1 is a block diagram of the electronic device in accordance with one embodiment; FIG. 2 is a three-dimensional diagram of the electronic device in accordance with one embodiment. A notebook computer is shown in figures, which is not limited herein. Any electronic device equipped with or connected with a dial as an input interface is applicable to the invention.

As shown in FIG. 1, an electronic device 100 includes a dial 120, a display 130, a setting unit 140, a control unit 150, a calculation unit 160, and a processing unit 170.

After the electronic device 100 is powered on, the dial 120 reports a rotation count N1 per unit time Tbase. For example, the unit time Tbase is 100 ms.

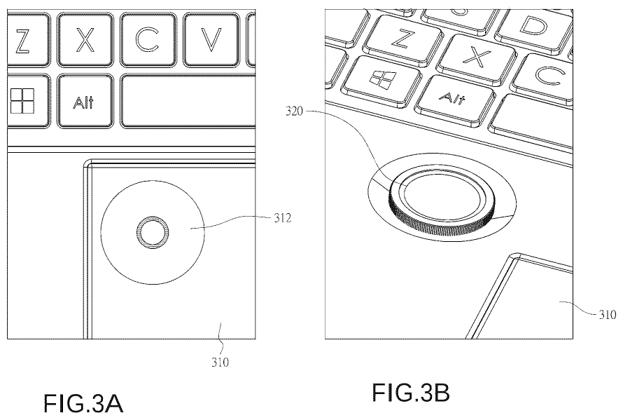

FIGS. 3A and 3B show the dial provided in accordance with two embodiments.

In the embodiment as shown in FIG. 3A, a surface of a touchpad 310 is provided with a dial pattern 312. In the embodiment, a software control method is applied to convert touch data received at the dial pattern 312 of the touchpad 310 into dial data for subsequent processing. That is, the dial function is integrated into the touchpad 310. The dial function is not performed by a physical dial in the embodiment.

As shown in FIG. 3B, the dial 320 is disposed on a side of the touchpad 310 and separates from the touchpad 310. In the embodiment, the dial function is performed via a physical dial 320.

The display 130 is configured to display a window of an application program AP and a user interface UI corresponding to the dial 120.

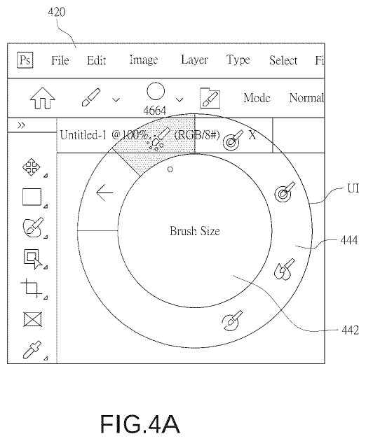

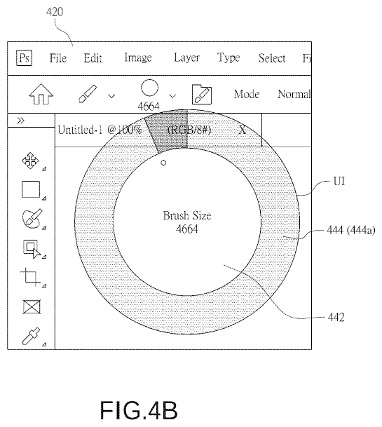

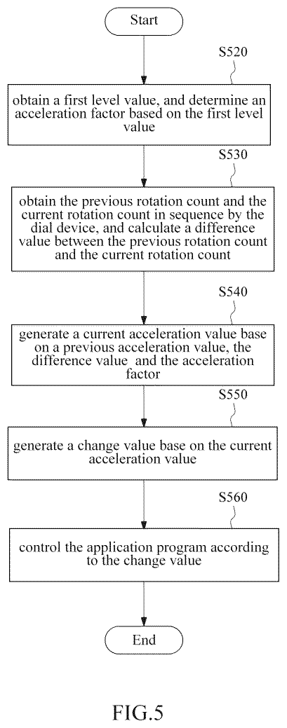

Please refer to FIGS. 4A and 4B. FIGS. 4A and 4B show an interface shown by the display in accordance with one embodiment. FIGS. 4A and 4B show a partial window of a drawing application program according to an embodiment of the invention.

As shown in FIGS. 4A and 4B, in one embodiment, the window 420 corresponding to the drawing application program is shown as a background on the display 130, and the user interface UI corresponding to the dial 120 is floated on the window 420. Moreover, in one embodiment, the user interface UI is semi-transparent to make the content of the window 420 viewable.

In the user interface UI, the appearance of the dial 120 includes an inner circular part 442 and an outer ring part 444. According to the corresponding application program AP, the user interface UI presents a two-level operation mode.

As shown in FIG. 4A, in the first-level operation interface, the outer ring part 444 of the user interface UI presents multiple adjustable control functions of the application program AP to be selected.

After one of the control functions is selected, as shown in FIG. 4B, the second-level operation interface is entered into immediately. The parameter values corresponding to the selected control function is shown on the inner circular part 442 of the user interface UI. Furthermore, in one embodiment, in order to show the change of parameter value intuitively, a ring-shaped section 444a is shown at the outer ring part 444 of the user interface UI, and a length of the ring-shaped section 444a represents the parameter values.

The setting unit 140 is configured to obtain a first level value L1, and determines an acceleration factor Fa and a deceleration factor Fb applicable to the input of the current dial 120 based on the first level value L1. The first level value L1 is used to determine acceleration/deceleration levels. Different first level values L1 correspond to different acceleration factors Fa and deceleration factors Fb.

Please refer to Table 1. Table 1 shows the acceleration/deceleration levels, and corresponding deceleration factors Fb and deceleration factors Fb.

TABLE 1

| acceleration/deceleration | acceleration | deceleration |
|---|---|---|
| factor level | factors Fa | factors Fb |
| 1 | acbase*3 | acbase |
| 2 | acbase*5 | acbase*2 |
| 3 | acbase*6 | acbase*3 |
| 4 | acbase*7 | acbase*4 |
| 5 | acbase*8 | acbase*5 |

As shown in Table 1, the setting unit 140 provides five acceleration/deceleration levels (level 1 to level 5) to be selected. Each level corresponds to an acceleration factor Fa and a deceleration factor Fb. Both the acceleration factor Fa and the deceleration factor Fb are set as integer multiples of a base acceleration value acbase. The multiples of the acceleration factor Fa and deceleration factor Fb relative to the base acceleration value acbase are the same or different, which is not limited herein.

Different first values levels L1 are selectable to change the acceleration/deceleration level. In an embodiment, the setting unit 140 determines the applicable acceleration factor Fa and deceleration factor Fb based on the first level value L1.

In one embodiment, as the level increases, the acceleration factor Fa and the deceleration factor Fb also increase accordingly, to present the acceleration and deceleration behaviors with significant variation in value. Furthermore, in one embodiment, in the same level, the acceleration factor Fa is greater than the deceleration factor Fb to match operation habits of users.

In above embodiment, based on the first level value L1, both the acceleration factor Fa and the deceleration factor Fb are set correspondingly, which is not limit herein. In other embodiments, one of the acceleration factor Fa and the deceleration factor Fb is set subsequent processing.

In an embodiment, the base acceleration value acbase is calculated and derived via the following Formula 1.

acbase=1.0/dbase Formula 1:

Wherein dbase represents a preset base movement distance, and acbase represents a corresponding minimum movement distance. For example, if dbase is a movement distance of 20 units, and acbase is a movement distance of 1 unit.

The control unit 150 is electrically connected to the dial 120, and is configured to obtain a previous rotation count Nprev and a current rotation count Ncurr in sequence of the dial 120. The control unit 150 also calculates the difference value Ndiff between the previous rotation count Nprev and the current rotation count Ncurr (Ndiff=Ncurr−Nprev).

When the unit time Tbase for calculating the rotational amplitude of the dial is 100 ms, the current rotational count Ncurr is the number of scale divisions rotated within the current unit time (100 ms), and the previous rotational count Nprev is the number of scale divisions rotated within the previous unit time (100 ms). If the current rotational count Ncurr is larger than the previous rotational count Nprev, an acceleration state is indicated. If the current rotational count Ncurr is less than the previous rotational count Nprev, a deceleration state is indicated.

The computing unit 160 is electrically connected to the control unit 150 and the setting unit 140. The computing unit 160 is adapted to generate a current acceleration value Accurr based on a previous acceleration value Acprev, the difference value Ndiff and the acceleration factor Fa. The computing unit 160 also generates a change value CV based on the current acceleration value Accurr. The previous acceleration value Acprev used in this calculation is the current acceleration value generated in the previous calculation and temporarily stored in the computing unit 160. The current acceleration value Accurr generated in this calculation by the calculation unit 160 is the previous acceleration value in the next calculation used by the calculation unit 160.

In one embodiment, in the acceleration state, the computing unit 160 calculates the current acceleration value Accurr via the following Formula 2.

Accurr−Acprev+(Ncurr−Nprev)*Fa*θ,Ncurr−Nprev Formula 2:

Similarly, in the deceleration state, the calculation unit 160 calculates the current acceleration value via the following Formula 3.

Accurr=Acprev−(Nprev−Ncurr)*Fb*θ,Ncurr−Nprev Formula 3:

Wherein θ represents a regulating coefficient for adjusting the amplitude of acceleration or deceleration factors under special conditions (such as significant acceleration or deceleration), and θ is a floating-point number greater than or equal to 1. Under a normal acceleration/deceleration condition, the regulating coefficient θ is 1.

When the acceleration condition is satisfied (that is, the current rotation count Ncurr is greater than the previous rotation count Nprev), the calculation unit 160 calculates the acceleration via Formula 2. When the absolute value of the difference value Ndiff between the current rotation count Ncurr and the previous rotation count Nprev is greater than a preset value, a special condition is satisfied; otherwise, the normal acceleration is satisfied, and the adjustment coefficient θ is set to 1.

Similarly, when the deceleration condition is satisfied (that is, the current rotation count Ncurr is less than or equal to the previous rotation count Nprev), the calculation unit 160 calculates the acceleration via Formula 3. When the absolute value of the difference value Ndiff between the current rotation count Ncurr and the previous rotation count Nprev is greater than a preset value or when the current rotation count Ncurr is 1, the special condition is satisfied; otherwise, the normal deceleration is satisfied and the adjustment coefficient θ is set to 1.

In one embodiment, the calculation unit 160 calculates the change value CV corresponding to the current unit time via the following Formula 4.

CV=Accurr*dbase Formula 4:

Wherein dbase is the basic movement distance. For detailed explanations, please refer to the previous paragraph corresponding to the basic acceleration value acbase.

The processing unit 170 is electrically connected to the calculation unit 160 and is configured to control the application program AP according to the change value CV. In one embodiment, the processing unit 170 directly adjusts the control parameter values of the control function of the application program AP based on the change value CV. For a drawing application program, the processing unit 170 directly adjusts the brush thickness, the color temperature, and other parameters based on the change value CV. In one embodiment, the processing unit 170 is a central processing unit (CPU).

In one embodiment, the setting unit 140 provides a plurality of upper and lower limit levels to be selected. The upper and lower limit levels are used to limit the range of the current acceleration value Accurr calculated by the calculation unit 160, to prevent the change value CV from unexpectedly increasing without control.

The second level value L2 is used to determine the upper/lower limit level accordingly. The second level value L2 is input as the upper/lower limit level accordingly to adjust an upper limit value UL and a lower limit value LL.

Please refer to Table 2. Table 2 shows the upper and lower limit levels, and the corresponding upper limit value UL and lower limit value LL.

| upper/lower limit level | upper limit value UL | lower limit value LL |
|---|---|---|
| 1 | acbase*20 | acbase |
| 2 | acbase*30 | acbase*10 |
| 3 | acbase*40 | acbase*15 |
| 4 | acbase*50 | acbase*20 |
| 5 | acbase*80 | acbase*30 |

As shown in Table 2, the setting unit 140 provides five upper/lower limit levels (level 1 to level 5) to be selected. Each level includes a corresponding upper limit value UL and a lower limit value LL, and both the upper limit value UL and the lower limit value LL are set as integer multiples of a base acceleration value acbase. The multiples of the upper limit value UL and the lower limit value LL relative to the base acceleration value acbase are the same or different.

One of the second level values L2 is selected to change the upper/lower limit levels accordingly. The setting unit 140 determines the applicable upper limit value UL and the lower limit value LL based on the second level value L2.

In one embodiment, as the level increases, the upper limit value UL and the lower limit value LL also increase accordingly, to show the acceleration and deceleration behaviors with significant variation. Furthermore, in one embodiment, the acceleration factor Fa is greater than the deceleration factor Fb in the same level to match operation habits of users.

Moreover, in an embodiment, the upper limit value UL and the lower limit value LL of the acceleration behavior are the same as these of the deceleration behavior, which is not limited herein. In an embodiment, the upper limit value UL and the lower limit value LL of the acceleration behavior are different from these of the deceleration behavior, so as to simulate rotation input behaviors of users more accurately.

In an embodiment, the calculation unit 160 calculates the current acceleration value Accurr via the following Formula 5.

Accurr=max(min(Accurr,UL),LL) Formula 5:

Via Formula 5, the calculation unit 160 limits the current acceleration value Accurr in the range defined by the upper limit value UL and the lower limit value LL corresponding to the second level value L2 obtained by the setting unit 140.

Please refer to FIG. 5. FIG. 5 is a flowchart of a dial control method in accordance with a first embodiment. The dial control method is applied to the electronic device 100 as shown in FIG. 1. The dial control method includes the following steps.

First, in step S520, a first level value L1 is obtained, and an acceleration factor Fa is determined based on the first level value L1. This step is executed by the setting unit 140. In an embodiment, in this step, the acceleration factor Fa and a deceleration factor Fb are determined at the same time for subsequent calculations.

Subsequently, as shown in step S530, a previous rotation count Nprev and a current rotation count Ncurr in sequence are obtained by the dial 120, and a difference value Ndiff between the previous rotation count Nprev and the current rotation count is calculated. In an embodiment, the step S530 is executed by the control unit 150.

Next, as shown in step S540, a current acceleration value Accurr is generated based on a previous acceleration value Acprev, the difference value Ndiff, and the acceleration factor Fa.

Subsequently, as shown in step S550, a change value CV is generated based on the current acceleration value Accurr. In an embodiment, the steps S540 and S550 are executed by the computing unit 160.

Then, as shown in step S560, the application program AP is controlled according to the change value CV. In an embodiment, the steps S560 step is executed by the processing unit 170. In an embodiment, in step S560, the change value CV is simultaneously shown on the user interface UI, for example, at the center of the dial pattern.

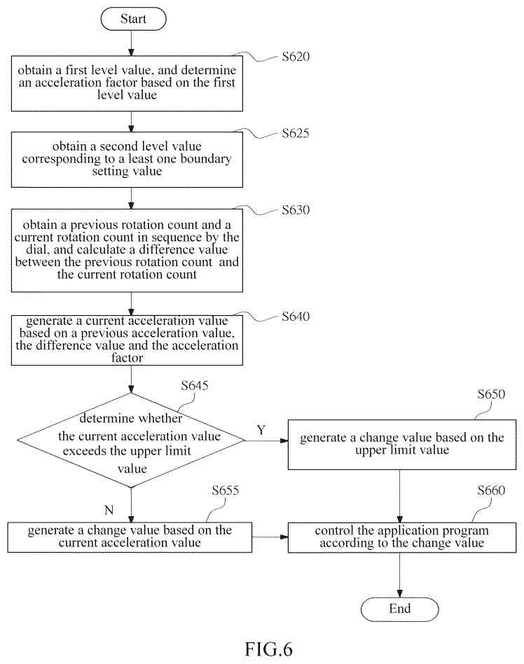

Please refer to FIG. 6. FIG. 6 is a flowchart of a dial control method in accordance with a second embodiment. This dial control method is applied to the electronic device 100 as shown in FIG. 1. This dial control method includes the following steps.

First, as shown in step S620, a first level value L1 is obtained and an acceleration factor Fa is determined based on the first level value L1. This step is executed by the setting unit 140.

Subsequently, as shown in step 625, a second level value L2 is obtained. The second level value L2 corresponds to at least a boundary setting value. The boundary setting value includes a group of an upper limit value UL and a lower limit valued LL. The step 625 is executed by the setting unit 140.

Next, as shown in step S630, a previous rotation count Nprev and a current rotation count Ncurr in sequence are obtained by the dial 120, and a difference value Ndiff between the previous rotation count Nprev and the current rotation count Ncurr is calculated. The step S630 is executed by the control unit 150.

Next, in step S640, a current acceleration value Accurr is generated based on a previous acceleration value Acprev, the difference value Ndiff, and the acceleration factor Fa.

Then, as shown in step S645, whether the current acceleration value Accurr exceeds the upper limit value UL is determined. If the current acceleration value Accurr exceeds the upper limit value UL, in step S650, a change value CV is generated based on the upper limit value UL.

If the current acceleration value Accurr does not exceed the upper limit value UL, in step S655, the change value CV is generated based on the current acceleration value Accurr. The above steps S640, S645, S650 and S655 are executed by the computing unit 160.

Then, as shown in step S660, the application program AP is controlled according to the change value CV. In an embodiment, the step S660 is executed by the processing unit 170.

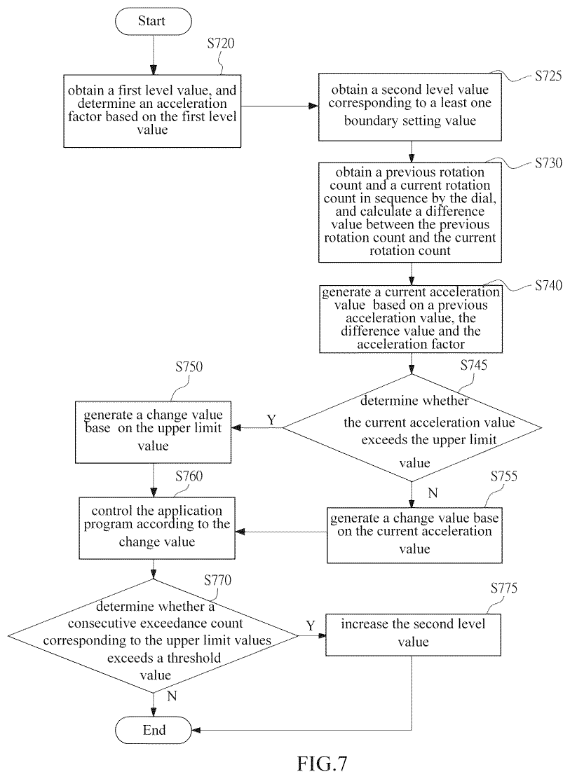

Please also refer to FIG. 7. FIG. 7 is a flowchart of the dial control method in accordance with a third embodiment. This dial control method is applied to the electronic device 100 as shown in FIG. 1. This dial control method includes the following steps.

First, as shown in step S720, a first level value L1 is obtained, and an acceleration factor Fa is determined based on the first level value L1.

Subsequently, as shown in step S725, a second level value L2 is obtained. The second level value L2 corresponds to at least a boundary setting value. The boundary setting value includes a group of an upper limit value UL and a lower limit valued LL. The steps S720 and S725 are executed by the setting unit 140.

Next, as shown in step S730, a previous rotation count Nprev and a current rotation count Ncurr in sequence are obtained by the dial 120, and a difference value Ndiff between the previous rotation count Nprev and the current rotation count Ncurr is calculated. In an embodiment, the step S730 is executed by the control unit 150.

Next, in step S740, a current acceleration value Accurr is generated based on a previous acceleration value Acprev, the difference value Ndiff and the acceleration factor Fa.

Then, in step S745, whether the current acceleration value Accurr exceeds the upper limit value UL is determined. If the current acceleration value Accurr exceeds the upper limit value UL, in step S750, a change value CV is generated base on the upper limit value UL. If the current acceleration value Accurr does not exceed the upper limit value UL, in step S755, the change value CV is generated base on the current acceleration value Accurr. The steps S740, S745, S750 and S755 are executed by the computing unit 160.

Then, as shown in step S760, the application program AP is controlled according to the change value CV. In an embodiment, the step S760 is executed by the processing unit 170.

Then, in step S770, whether a consecutive exceedance count Chigh corresponding to the upper limit values UL exceeds a threshold value Nth is determined. In an embodiment, in step S770, whether the consecutive exceedance count Chigh in a determining time interval exceeds the threshold Nth is determined. The determining time interval is longer than the unit time Tbase. In an embodiment, the determining time interval is 500 ms.

If the consecutive exceedance count Chigh exceeds the threshold value Nth, in step S775, the second level value L2 is increased. In an embodiment, in step S775, the second level value L2 is raised to a next level. If consecutive exceedance count Chigh does not exceed the threshold Nth, the process ends. The steps S770 and S775 are automatically executed by the computing unit 160 cooperating with the setting unit 140.

In the above determining steps S770 and S775, whether the consecutive exceedance count corresponding to the upper limit value UL exceeds a threshold Nth is determined, which is not limited herein. In an embodiment, whether the consecutive exceedance count corresponding to the lower limit value LL exceeds a threshold Nth is also determined according to the dial control method, and when the consecutive exceedance count Clow exceeds the threshold Nth, the second level value L2 is decreased.

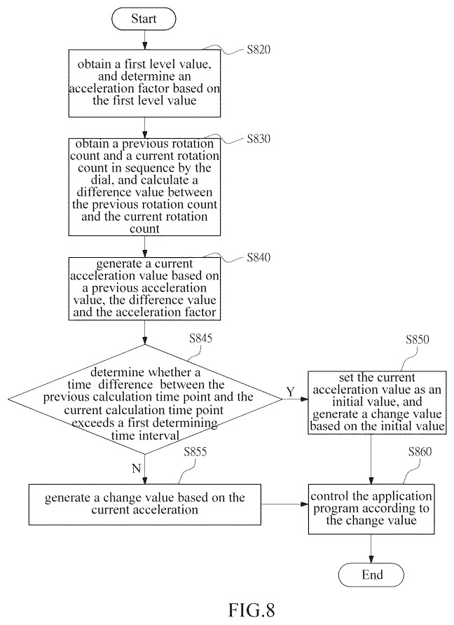

Please also refer to FIG. 8. FIG. 8 is a flowchart of the dial control method in accordance with a fourth embodiment. The dial control method is applied to the electronic device 100 as shown in FIG. 1. The dial control method includes the following steps.

First, as shown in step S820, a first level value L1 is obtained, and an acceleration factor Fa is determined based on the first level value L1. This step is executed by the setting unit 140.

Subsequently, as shown in step S830, a previous rotation count Nprev and a current rotation count Ncurr in sequence are obtained by the dial 120, and a difference value Ndiff between the previous rotation count Nprev and the current rotation count Ncurr is calculated. The step 830 is executed by the control unit 150.

Next, in step S840, a current acceleration value Accurr is generated based on a previous acceleration value Acprev, the difference value Ndiff and the acceleration factor Fa.

The previous acceleration value Acprev corresponds to a previous calculation time point T1. The current acceleration value Accurr corresponds to the current calculation time point T2.

Subsequently, in step S845, whether a time difference DT between the previous calculation time point T1 and the current calculation time point T2 exceeds a first determining time interval Tth is determined. The first determining time interval Tth is longer than the unit time Tbase. For example, the first determining time interval Tth is 500 ms, and the unit time Tbase is 100 ms.

If the time difference DT between the previous calculation time point T1 and the current calculation time point T2 exceeds the first determining time interval Tth, in step S850, the current acceleration value Accurr is set as an initial value, and the change value CV is generated based on the initial value.

If the time difference DT between the previous calculation time point T1 and the current calculation time point T2 does not exceed the first determining time interval Tth, in step S855, the change value CV is generated based on the current acceleration value Accurr. In an embodiment, the steps S840, S845, S850 and S655 are executed by the computing unit 160.

Then, as shown in step S860, the application program AP is controlled according to the change value CV. The step S860 is executed by the processing unit 170.

The first determining time interval Tth is regarded as a condition factor, it allows the calculation of the acceleration value to return to an initial setting, to reflect an operation of pausing the rotation operation.

In embodiments of FIG. 5 to FIG. 8, acceleration operations of the dial 120 are illustrated, which is not limited herein. The deceleration operations of the dial 120 are also appliable. when the deceleration operation is performed on the dial 120, the deceleration factor Fb is used instead of the original acceleration factor Fa. Other steps are similar to those in the control flows described in FIG. 5 to FIG. 8, which are not described again for a concise purpose.

In the dial control method of the embodiments, the acceleration factor Fa is set, the difference value Ndiff between the previous rotation counts Nprev and current rotation counts Ncurr in sequence is obtained by the dial 120. The current acceleration value Accurr is calculated based on the difference value Ndiff, the acceleration factor Fa, and the previous acceleration value Acprev. Consequently, the output change value CV is adjusted flexibly by changing the rotation speed or the rotation magnitude of the dial 120. As a result, a sudden change in value is avoided effectively.

Although the show invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. A dial control method, applied to an electronic device, the electronic device includes a display and a dial, the display is adapted to display a window of an application program and a user interface corresponding to the dial, the dial reports a rotation count per unit time, the dial control method includes:
obtaining a first level value, and determining an acceleration factor based on the first level value;
obtaining a previous rotation count and a current rotation count in sequence by the dial, and calculating a difference value between the previous rotation count and the current rotation count;
generating a current acceleration value based on a previous acceleration value, the difference value, and the acceleration factor;
generating a change value based on the current acceleration value; and
controlling the application program according to the change value.

2. The dial control method according to claim 1, further comprising:
displaying the change value on the user interface.

3. The dial control method according to claim 1, wherein the unit time is 100 ms.

4. The dial control method according to claim 1, further comprising:
obtaining a second level value, and determining at least a boundary setting value based on the second level value.

5. The dial control method according to claim 4, wherein the boundary setting value is chosen from a group composed of an upper limit value and a lower limit value.

6. The dial control method according to claim 4, wherein the boundary setting value includes an upper limit value.

7. The dial control method according to claim 6, further comprising:
generating the change value based on the upper limit value when the current acceleration value exceeds the upper limit value.

8. The dial control method according to claim 7, further comprising:
determining a consecutive exceedance count corresponding to the upper limit value when the current acceleration value exceeds the upper limit value; and
increasing the second level value when the consecutive exceedance count exceeds a threshold value.

9. The dial control method according to claim 1, wherein the previous acceleration value corresponds to a previous calculation time point, and the current acceleration value corresponds to a current calculation time point.

10. The dial control method according to claim 9, further comprising:
setting the current acceleration value as an initial value and generating the change value based on the initial value when a time difference between the previous calculation time point and the current calculation time point exceeds a first determining time interval.

11. The dial control method according to claim 10, wherein the first determining time interval is longer than the unit time.

12. The dial control method according to claim 1, wherein the first level value corresponds to the acceleration factor and a deceleration factor.

13. An electronic device, comprising:
a dial, reporting a rotation count per unit time;
a display, adapted to display a window of an application program and a user interface corresponding to the dial;
a setting unit, adapted to obtain a first level value and determine an acceleration factor based on the first level value;
a control unit, electrically connected to the dial, the control unit is configured to obtain a previous rotation count and a current rotation count in sequence by the dial, and calculate a difference value between the previous rotation count and the current rotation count;
a calculation unit, electrically connected to the control unit and the setting unit, the calculation unit is configured to generate a current acceleration value based on a previous acceleration value, the difference value, and the acceleration factor, and generate a change value based on the current acceleration value; and
a processing unit, electrically connected to the calculation unit and configured to control the application program according to the change value.

14. The electronic device according to claim 13, wherein the setting unit is configured to determine the acceleration factor and a deceleration factor based on the first level value.
